(19) United States
(12) Patent Application Publication
(10) Pub. No.: US 2011/0276894 A1
(43) Pub. Date: Nov. 10, 2011

(54) SYSTEM, METHOD, AND COMPUTER PROGRAM PRODUCT FOR MULTI-USER FEEDBACK TO INFLUENCE AUDIOVISUAL QUALITY

(76) Inventors: Audrey Younkin, Hillsboro, OR (US); Philip Corriveau, Forest Grove, OR (US); Glen Anderson, Beaverton, OR (US)

(21) Appl. No.: 12/775,831

(22) Filed: May 7, 2010

(51) Int. Cl. G06F 3/048; G06F 15/16

(52) U.S. Cl. 715/751

(57) ABSTRACT

System, method, and computer program product to collect user settings regarding the quality of audiovisual (AV) content, and to change the quality of the content based on the collected settings. Users may provide input regarding tradeoffs in AV quality, such as audio quality versus video quality, or audio quality versus delay. The inputs of the users may be averaged, to generate a single input that reflects the inputs of all the users. This single input may then be used to determine one or more parameters that may be applied in defining the tradeoff(s) implemented in AV content capture, processing, or delivery.

### BACKGROUND

With recent advances in networking technology, it is now common for users to receive audiovisual content, sometimes in near realtime. Examples include voice and video teleconferences, webinars, and live streaming of events such as concerts, news stories, and sporting events. Further, during the delivery of such content, a number of parameters may be applied to the capture, processing, and delivery of the content to users, parameters that affect the quality of the experience for the user. These parameters may include, for example, sampling rates, coding parameters, and data throughput rates.

Moreover, one or more of the users may have preferences with regard to these parameters, given that a user typically wants the best possible AV experience. A selection of a parameter value may entail a tradeoff, however. For example, during a video conference, participants may be having an active discussion, in which case low audio lag time might be desired. Here, users want to feel as if they are in the same room together, having a face-to-face conversation; any significant lag time is a distraction. But a reduction in delay may reduce the quality of the video. Improving video could conversely increase delay, and may also reduce audio quality. In some situations, certain tradeoffs may be acceptable. During the same videoconference, for example, a demonstration of something visual like an industrial design or a fabric may be demonstrated, in which case lag and lower audio quality may acceptable for the sake of higher video quality.

In another example, during a broadcast concert, most users may prefer to hear higher quality audio at the expense of video during parts of the broadcast when performers are simply standing there singing. For example, reducing the bit rate encoding of video can allow higher audio quality in a given AV stream. During other parts of the program, seeing high quality video may become more desirable.

Making intelligent trade-offs with respect to media quality can be difficult for service providers or automated systems. The end users' desired quality level may differ based on the users' display size, user preferences for video versus audio, acceptability of audio lag for that experience, or even the nature of the content. High AV quality may be more important in some situations than others.

For media broadcasts, settings for voice over the internet protocol (VOIP) or video conferences (i.e., trade-off levels) may be decided by designers or technicians without input from the users. A technician, for example, may follow instructions or make a judgment on what is hopefully the best trade-off. Automatic adjustments can also occur based on network throughput variance. Mathematical modeling of network traffic and attempts to prioritize video and audio packets may take place, but this may not address or support a user's desired experience, or the desires of a set of users.

### BRIEF DESCRIPTION OF THE DRAWINGS/FIGURES

FIG. 1a is a block diagram illustrating processing of the system described herein, where the averaging of user settings may be performed at a media server and averaged settings may be applied at a capture device, according to an embodiment.

FIG. 1b is a block diagram illustrating the system described herein, where the averaging of user settings may be performed at a media server and averaged settings may be applied at the server, according to an embodiment.

FIG. 2 is a block diagram illustrating processing of the system described herein, where the averaging of user settings may be performed at a capture device and averaged settings may be applied at the capture device, according to an embodiment.

FIG. 3 illustrates a graphical user interface (GUI) through which a user may select AV quality trade-offs, according to an embodiment.

FIG. 4 is a flowchart illustrating a process for collecting, processing, and applying user settings for determination of AV trade-offs, according to an embodiment.

FIG. 5 is a block diagram illustrating a software or firmware embodiment of the system described herein.

### DETAILED DESCRIPTION

A preferred embodiment is now described with reference to the figures, where like reference numbers indicate identical or functionally similar elements. Also in the figures, the leftmost digit of each reference number corresponds to the figure in which the reference number is first used. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are systems, methods, and computer program products to collect user input regarding the quality of audiovisual (AV) content, and to change the quality of the content based on the collected input. Users may provide input regarding tradeoffs in AV quality, such as audio quality versus video quality, or audio quality versus delay. The inputs of the users represent selected settings as to the trade-offs. These may be averaged to generate one or more average settings that reflect the inputs of all the users. The average setting(s) may then be used to determine one or more parameters that may be applied in AV content capture, processing and/or delivery.

This may be applicable, for example, in video-teleconferencing, live podcasting, playing of pre-recorded media, distance learning, virtual meetings and on-line collaborative environments where multiple users may be participating. The systems and methods described herein allow a set of users to exercise control over the AV experience. Two points where AV quality can be impacted are 1) at the AV capture device, and 2) at the server that distributes media streams. As will be described below, either one or both points may be used.

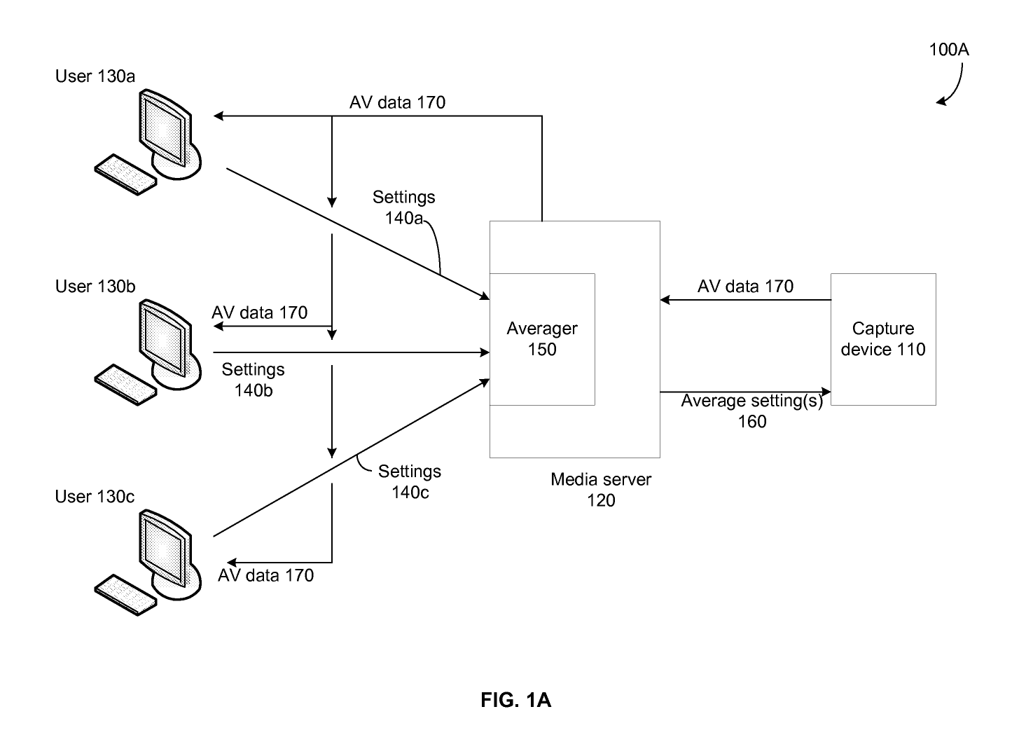

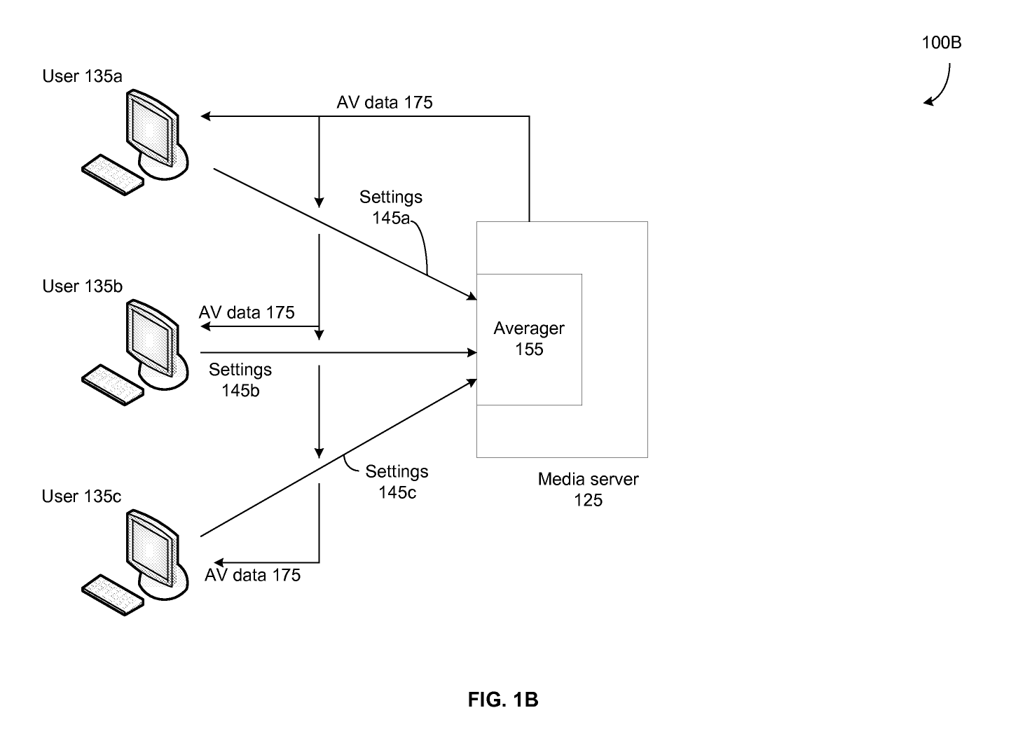

FIGS. 1A and 1B show embodiments where user-selected settings may be sent to a media server, where they may be processed by an averager (to be described in greater detail below). In FIG. 1A, audio and/or video may be captured by a capture device 110. AV data 170 may be produced by capture device 110, and sent to a media server 120. The AV data 170 may then be sent by media server 120 to each of several users 130a-130c. The users 130a-130c may each provide settings, shown as 140a-140c respectively, to the media server 120. These settings 140 represent input from each of the users 130 regarding trade-offs selected by the individual users. As discussed above, the user may, for example, choose higher audio quality and accept the resulting lower video quality, or vice versa. Alternatively or in addition, the user may choose to accept a greater delay in favor of higher audio or video quality, or may prefer less delay and accept the poorer audio or video quality that results. In an embodiment, a user may be provided with a graphical user interface (GUI) that allows settings to be selected over a discrete set of choices, or over a continuous range. In the embodiment of FIG. 1A, these selections may be conveyed to media server 120 by users 130 in the form of settings 140a-140c.

As would be understood by a person of ordinary skill in the art, settings 140 may represent one or more specific numerical values. By choosing a particular setting, for example, a user 130 may be effectively specifying a particular bit rate, sampling rate, or coding or filtering parameter. When the settings 140 are received at media server 120, the corresponding numerical values may be processed by a module 150. For each type of setting selected by users (e.g., video quality versus audio quality) module 150 may produce a single setting that may reflect or may be a function of each of the individual settings 140. In the embodiment of FIG. 1A, module 150 may be an averager. In this embodiment, the averager 150 may, for example, calculate the arithmetic mean of the settings 140a-140c. In some embodiments, averager 150 may calculate a weighted average. In such an embodiment, the setting 140 of a particular user 130 may be given greater priority or deference, as reflected in a greater weight than that given to the other users. In other embodiments, the module 150 may execute a different statistical function. This module may generate a median value instead of a mean value, for example.

The output of the averager 150 is shown as one or more average settings 160. The average setting 160 may then be sent to the capture device 110, where the average setting 160 may be implemented. In this way, the choices made by the individual users 130 may be processed and sent to the capture device 110, which may then respond by making corresponding adjustments to the appropriate parameters.

In an embodiment of the invention, the settings 140 may be chosen by users 130 after the presentation of AV data 170 has already started. This would allow users 130 to receive AV data 170 as produced with default parameters. Users 130 may then input settings 140 in accordance with their reaction to the AV data 170 as produced using these default parameters. Settings 140 would therefore represent feedback in such an embodiment. Alternatively, users 130 may input settings 140 before the presentation of any AV data. This would allow users 130 to provide input at the outset of a presentation.

FIG. 1B illustrates an alternative embodiment, where revised parameters may be implemented at a media server. Here, users 135a-135c provide respective settings 145a-145c. The settings 145 may be received at media server 125, where they may be processed by an averager 155. In this embodiment, the output of the averager 155 may not be sent to a capture device. Rather, the output of the averager 155 may be used internally at media server 125. Here parameters may be adjusted and implemented in accordance with an average setting produced by the averager 155 as a function of the individual settings 145a-145c. In this embodiment, note that the parameters adjusted and implemented at the media server 125 may be different from those parameters that are adjusted and implemented at capture device 110 in FIG. 1A. This is because certain parameters may not be modifiable at a media server, even though they may be modifiable at a capture device, and vice versa. A sampling rate may be modifiable at a capture device, for example, but not at a media server.

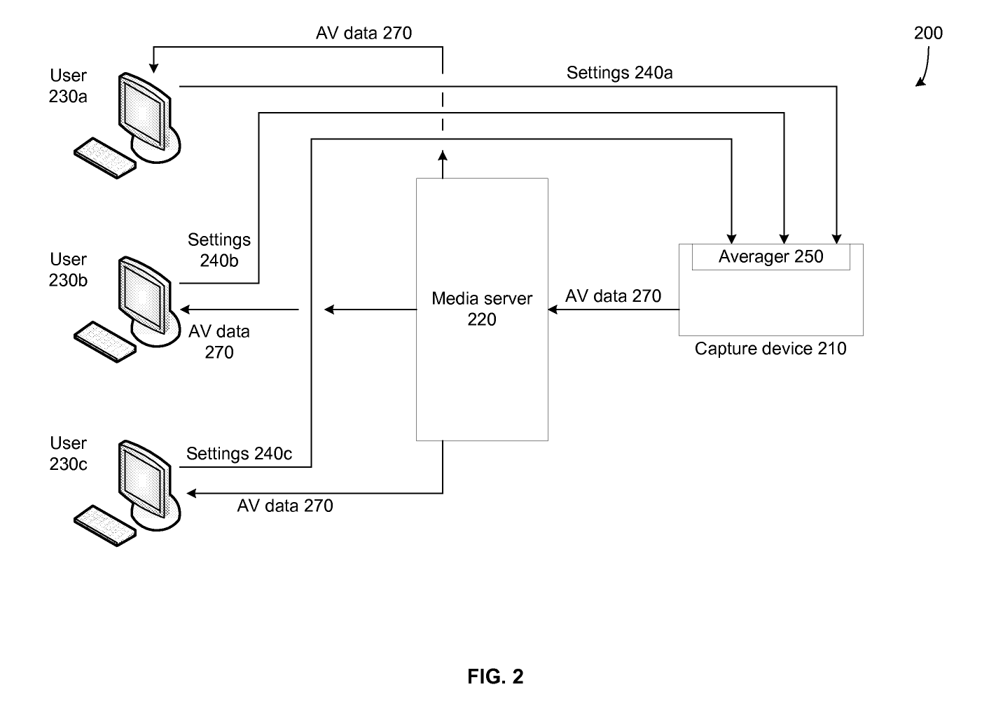

FIG. 2 illustrates an embodiment where the averager may be located at the capture device, rather than at the media server. A capture device 210 may include an averager 250. AV data 270 may be sent from capture device 210 to media server 220. The media server 220 may then forward the AV data 270 to each of several users, 230a-230c. As in the previous cases, each user may generate one or more settings, shown here as settings 240a-240c. As before, the settings represent selections, on the part of the users, regarding trade-offs as to the quality of the AV experience. A given user may prefer a higher level of video quality and may accept a lower level of audio quality, for example, and this would be indicated in the settings selected by that user. In addition, or in the alternative, a user may prefer to sacrifice a certain amount of delay in the presentation, in exchange for improved AV quality. As before, a given setting may represent one or more parameters used in the capture and/or processing of AV data 270. The parameters, as reflected in the settings under 240, may be averaged by averager 250, at the capture device 210. The resulting output of averager 250 may then be used to adjust parameters that are applied at capture device 210. As before, settings 240 may be selected and processed by averager 250 either before or after the presentation of AV data 270 has commenced.

Note that in FIGS. 1A, 1B, and 2 three users are shown; in reality, the number of users may be greater or fewer. In addition, the connections between the capture device, the media server, and the users, may use wired or wireless media, and may pass over one or more networks. The networks may include local area networks, wide-area networks, the Internet, or any combination thereof.

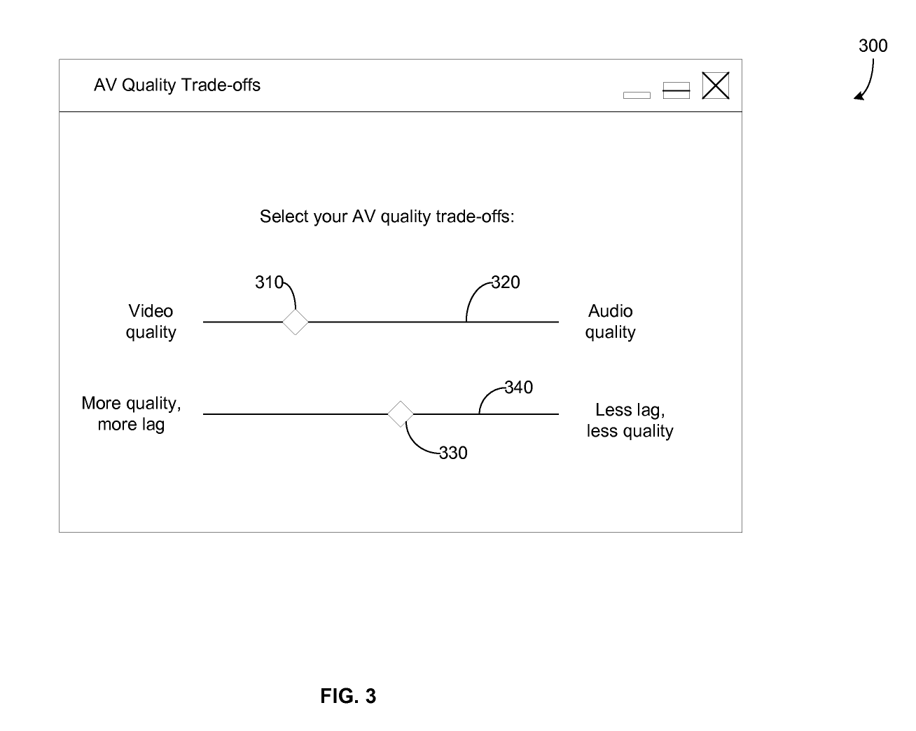

In an embodiment, a user may make his selection of an AV quality trade-off through the use of a graphical user interface (GUI). Such a GUI is shown in FIG. 3, according to an embodiment. This figure shows a window 300 which includes two ranges, 320 and 340. Range 320 may correspond to a range of possibilities with respect to the trade-off between video quality and audio quality. The user may manipulate a slider 310 along range 320. Moving slider 310 further to the left results in higher video quality and lower audio quality. Moving slider 310 to the right results in lower video quality, but higher audio quality. Range 340 corresponds to a range of possibilities with respect to the trade-off between AV quality and delay, or “lag.” Moving slider 330 to the left results in higher AV quality, but more lag. Moving slider 330 to the right results in lower AV quality but less lag.

The use of horizontally oriented sliders is not meant to be a limitation. As would be understood by a person of ordinary skill in the art, other graphical interfaces may be possible. Comparable functionality could be achieved, for example, through the use of graphically rendered knobs, switches, etc. Text boxes could also be used, where a user could type, in a verbal or numerical format (e.g., a number between 1 and 100) the amount of video quality desired, for example. An associated box could then show the resulting audio quality as a number between 1 and 100. Moreover, in alternative embodiments, only one of the two illustrated ranges may be available for manipulation. In other embodiments, additional trade-offs (not shown) may be presented.

By manipulating a graphically rendered control, such as slider 310 or 330, a user may be pointing to a particular pixel in a window or display. In an embodiment, the settings generated and sent by a user may be in the form of display coordinates. The coordinates may then be averaged, by the averager, along with the coordinates identified by the other users. The average coordinates may then be converted to values of one or more parameters that may be applied at a capture device or a media server. Such parameters may include a data rate or a sampling rate, for example. In such an embodiment, logic that converts coordinates to parameter values may reside at or with the averager.

Alternatively, such conversion logic may reside locally at the user machines. Here, users' selected pixel coordinates may be converted locally to one or more parameter values. The settings sent by users therefore may take the form of parameter values, which may be received by the averager for calculation of average parameter values.

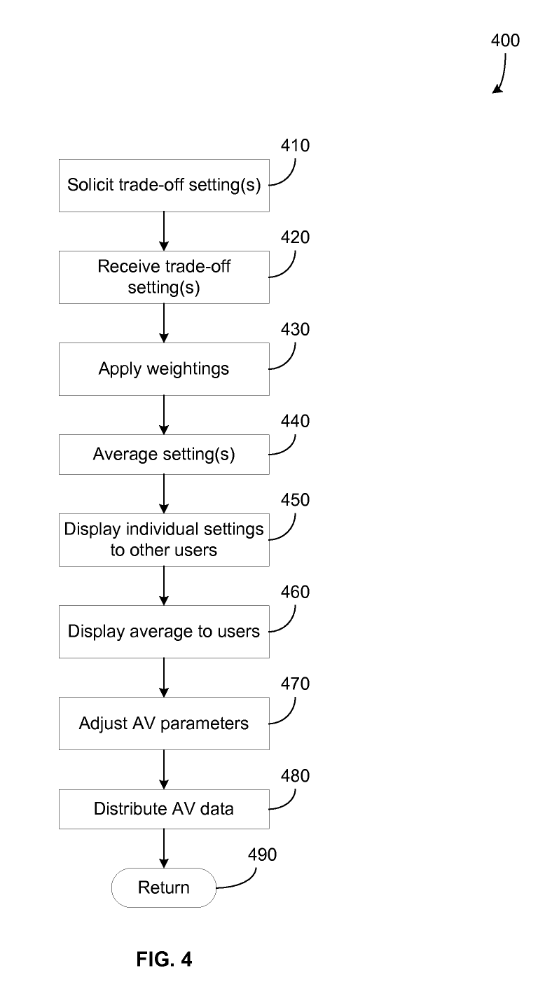

The processing of the system described herein is illustrated in FIG. 4, according to an embodiment. At 410, one or more trade-off settings may be solicited from each user. One way in which this could be done is through the use of a graphical user interface, such as that shown in FIG. 3. At 420, the settings may be received. If the averager calculates average settings by using a weighted average, then at 430, the weightings may be applied. If a conventional numerical average is calculated, as opposed to a weighted average, then weightings are not needed.

At 440, the average settings may be calculated. Note that if a user does not make any selection, then in an embodiment, the average may be calculated on the basis of one less participant. In other words, if there are n users involved and one user does not enter a setting, then the average may be calculated on the basis of n−1 users. Alternatively, such a user may be assigned a default setting, and the average calculated on the basis of all n users.

In an embodiment, the users may be informed as to the settings chosen by other users. In this case, at 450, other users' settings may be displayed to each user. Alternatively, the viewing of others' settings may be a display option that a user can choose or decline. At 460, the calculated average maybe displayed to the users. Again, viewing this value may be a display option that a user can choose or decline. At 470, the AV parameters may be adjusted in a manner consistent with the calculated average setting(s). At 480, the AV data may be presented to the users after application of the average setting(s).

Note that in alternative embodiments, not all of the information described in FIG. 4 may be available to the users. For example, in such embodiments, average settings may not be viewable by users. Likewise, the settings of other users may not be viewable.

One or more features disclosed herein may be implemented in hardware, software, firmware, or combinations thereof, including discrete and integrated circuit logic, application specific integrated circuit (ASIC) logic, and/or microcontrollers, or may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

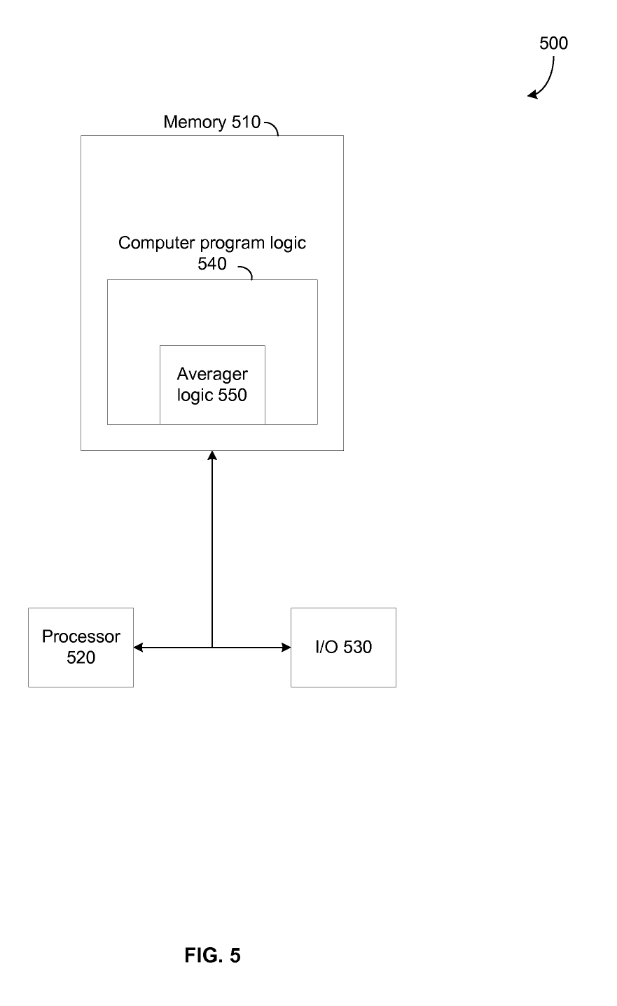

A software embodiment is illustrated in the context of a computing system 500 in FIG. 5. System 500 may include a processor 520 and a body of memory 510 that may include one or more computer readable media that may store computer program logic 540. Memory 510 may be implemented as a hard disk and drive, a removable media such as a compact disk and drive, or a read-only memory (ROM) device, for example. Processor 520 and memory 510 may be in communication using any of several technologies known to one of ordinary skill in the art, such as a bus. Computer program logic 540 contained in memory 510 may be read and executed by processor 520. One or more I/O ports and/or I/O devices, shown collectively as I/O 530, may also be connected to processor 520 and memory 510.

Computer program logic 540 may include averager logic 550, according to an embodiment. Averager logic 550 may be responsible for processing the settings received from users. In particular, logic 550 may receive the settings and calculate one or more output values that may be functions of the settings, wherein the output value(s) reflect each individual setting. As discussed above, the functions may include an arithmetic mean, or may include a weighted average. Alternatively, averager logic 550 may calculate some other statistical function of the settings.

Methods and systems are disclosed herein with the aid of functional building blocks that illustrate the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
receiving one or more audiovisual (AV) settings that are selected and provided by a respective plurality of users;
calculating a function of the inputs; and
determining one or more parameters affecting the capture or delivery of AV data to the users, where the parameters are determined by the output of the function, wherein said receiving, calculation, and determination are performed by a programmable processor.

2. The method of claim 1, wherein the processor is located at a media server in communication with the users.

3. The method of claim 1, wherein the processor is located at a content capture device that is configured to capture AV content.

4. The method of claim 1, wherein the control inputs specify a trade-off between one or more of
video quality versus audio quality, and
AV quality versus AV lag.

5. The method of claim 1, wherein the function is an arithmetic mean of the received settings.

6. The method of claim 1, wherein the parameters are used at a capture device to control capture or processing of AV content.

7. The method of claim 1, wherein the parameters are used at a media server to control processing or delivery of the AV data to the users.

8. A system, comprising:
a processor; and
a memory in communication with said processor, said memory for storing a plurality of processing instructions for directing said processor to:
receive one or more audiovisual (AV) settings that are selected and provided by a respective plurality of users;
calculate a function of the settings; and
determine one or more parameters affecting the capture or delivery of AV data to the users, where the parameters are determined by the output of the function.

9. The system of claim 8, wherein the processor is located at one of:
a media server in communication with the users, or
a content capture device that is configured to capture AV content.

10. The system of claim 8, wherein the settings specify a trade-off between one or more of
video quality versus audio quality, and
AV quality versus AV lag.

11. The system of claim 8, wherein the function is an arithmetic mean of the received control settings.

12. The system of claim 8, wherein the parameters are used at a capture device to control capture or processing of AV content.

13. The system of claim 8, wherein the parameters are used at a media server to control processing or delivery of the AV data to the users.

14. A computer program product comprising a computer useable medium having computer program logic stored thereon, the computer control logic comprising:
logic configured to cause a processor to receive one or more audiovisual (AV) control settings, selected and provided by a respective plurality of users;
logic configured to cause the processor to calculate a function of the inputs; and
logic configured to cause the processor to determine one or more parameters affecting the capture or delivery of AV data to the users, where the parameters are determined by the output of the function.

15. The computer program product of claim 14, wherein the processor is located at a media server in communication with the users.

16. The computer program product of claim 14, wherein the processor is located at a content capture device that is configured to capture AV content.

17. The computer program product of claim 14, wherein the control inputs specify a trade-off between one or more of
video quality versus audio quality, and
AV quality versus AV lag.

18. The computer program product of claim 14, wherein the function is an arithmetic mean of the received control settings.

19. The computer program product of claim 14, wherein the parameters are used at a capture device to control capture or processing of AV content.

20. The computer program product of claim 14, wherein the parameters are used at a media server to control processing or delivery of the AV data to the users.
